(19) United States
(12) Patent Application Publication
(10) Pub. No.: US 2026/0255284 A1
(43) Pub. Date: Aug. 27, 2026

(54) METHOD FOR DEPLOYING A NODE DEVICE ON SITE

(71) Applicant: SAGEMCOM ENERGY & TELECOM SAS, Bois-Colombes (FR)

(72) Inventors: El Kefi HLEL, Bois-Colombes (FR); Kaveh RAZAZIAN, Bois-Colombes (FR)

(73) Assignee: SAGEMCOM ENERGY & TELECOM SAS, Bois-Colombes (FR)

(21) Appl. No.: 19/538,723

(22) Filed: Feb. 12, 2026

(30) Foreign Application Priority Data
Feb. 24, 2025 (FR) 2501885

(51) Int. Cl. H04W 52/36

(52) U.S. Cl. CPC H04W 52/367

(57) ABSTRACT

A method for deploying on site a node device comprising a PLC interface and an RF interface, each configured to implement a procedure for connecting the node device to any one of a plurality of communication networks, each of the communication networks being of the mesh type and including a concentrator device to which a node device can connect. The method is implemented by electronic circuitry included in the node device. The method includes, at the initial start-up and then at each hardware or software reboot of the node device: gradually increasing an RF transmission power of the RF interface when the connection procedure is implemented. This makes it possible to eliminate or reduce the phenomenon of migration from a favourite communication network to a neighbouring communication network, in particular when the deployment is implemented in an urban environment.

### TECHNICAL FIELD

The field of the invention is that of communication networks of the mesh type comprising a concentrator device to which a set of node devices can connect.

More precisely, the present invention relates to a method for deploying on site a hybrid node device, comprising a powerline communication (PLC) interface and a radio-frequency (RF) communication interface, each of the PLC and RF interfaces being configured to implement a procedure for connecting the node device to any one of a plurality of communication networks.

The present invention also relates to a node device, as well as a computer program product and a storage medium for implementing such a method.

The present invention applies in particular, but not exclusively, in the case where the node device is a communicating meter (also called a smart meter), for example a smart electricity meter, used for a smart metering application.

### PRIOR ART

In a known manner, many communication networks have a topology (at least at logical level) in tree form to make it possible to extend the range of communications. The devices of such a communication network are generally called nodes, or node devices. A concentrator device (also called a “data concentrator” or “base node”) fulfils the role of root of the communication network and manages the communication network so as to organise the sharing of one and the same communication medium. Node devices then serve as relays on behalf other node devices in the communication network when the latter devices do not manage to directly receive information from the concentrator device.

Such communication networks are found in particular in the context of electricity supply networks of the AMM (“Automated Meter Management”) type, using automatic management of electricity meter readings and in which communications are established between communicating electricity meters (also called “smart meters”) and a data concentrator device.

In the remainder of the description, a particular category of node device is considered, referred to as PLC and RF hybrids because they comprise two communication interfaces: one by powerline (PLC) and the other by radiofrequency (RF). Thus, to communicate with the other node devices or with the concentrator device, each hybrid node device can use a PLC connection or an RF connection. In other words, with a PLC and RF hybrid communication technology as communication technology, for example in smart metering applications, the node devices (for example smart electricity meters) and the concentrator device are provided with a dual PLC and RF communication interface. Among these technologies, mention can be made of: the G3-PLC standard, specified in ITU-T Recommendation G.9903 as from the 2021 version, which incorporates the hybrid mode, and the PRIME standard, as from the 2022 version, which incorporates the hybrid mode.

For example, when it is connected to a personal area network (PAN), a hybrid smart electricity meter can send beacon frames (“beacons”) over its two PLC and RF communication interfaces. Ideally, this enables it to use one or other of its two PLC and RF interfaces to connect to a favourite personal area network. Favourite personal area network for an electricity meter means the personal area network the concentrator device of which is installed in the LV (low voltage) electricity transformer substation from which the electrical distribution network on which this electricity meter is installed originates.

The PLC signals are physically blocked by the LV electricity transformer substations. Consequently, when it uses its PLC communication interface to connect, an electricity meter can connect only to its favourite personal area network (as defined above).

On the other hand, the RF signals are not blocked by the LV electricity transformer substations and can therefore propagate from one geographical area to another (each geographical area corresponding to a distinct personal area network), in particular by deploying in an urban environment where the adjacent geographical areas are very close to one another. Consequently, when it uses its RF communication interface to connect, it may happen that an electricity meter does not always connect to its favourite personal area network. This is because, with its RF interface, the electricity meter may sometimes connect to another personal area network, a so-called neighbouring one, the concentrator device of which is installed in an LV electricity transformer substation other than the substation from which the electrical distribution network on which the electricity meter is installed originates.

In other words, because of the use of an RF interface, there is then a migration (undesired) of the PLC and RF hybrid smart electricity meter, from the favourite personal area network to the neighbouring personal area network. Migration from a favourite geographical area, associated with the favourite personal area network, to a neighbouring geographical area, associated with the neighbouring personal area network, is also spoken of.

One drawback of this migration phenomenon is that it creates an imbalance between the various personal area networks, some concentrator devices being able to find themselves managing the reading of electricity consumption measurements of a large number of smart electricity meters whereas other concentrator devices on the other hand are managing the reading of electricity consumption measurements of only a very small number of smart electricity meters.

Another drawback of this migration phenomenon is that it has a negative influence on the communicability of the smart electricity meters within some personal area networks. This is because, in an urban geographical area managed by a concentrator device, a migration of a certain number of electricity meters, from a personal area network associated with this geographical area to other personal area networks associated with other adjacent geographical areas, causes a reduction in the number of remaining electricity meters that will form the personal area network in question. This reduction negatively influences the communicability of the meters belonging to this personal area network in the light of the mesh nature of such a personal network. For the record, in a personal area network comprising hybrid smart meters, the electricity meters cooperate via PLC and RF connections to construct a reliable mesh network for the purpose of enabling an electricity meter to communicate effectively with the concentrator device via a certain number of PLC and RF communication connections.

There is therefore a need to provide a solution for the deployment on site of a PLC and RF hybrid node device (for example a smart meter) making it possible to eliminate or reduce the phenomenon of migration from the favourite communication network to the neighbouring communication network, in particular when such deployment is implemented in an urban environment.

### DISCLOSURE OF THE INVENTION

A method is proposed for deploying on site a hybrid node device comprising a first powerline communication interface, referred to as a PLC interface, and a second radio-frequency communication interface, referred to as an RF interface, each of the PLC and RF interfaces being configured to implement a procedure for connecting the node device to any one of a plurality of communication networks, each of the communication networks being of the mesh type and comprising a concentrator device to which a set of node devices can connect, the method being implemented by electronic circuitry included in the node device, the method comprising, at initial start-up and then at each hardware or software reboot of the node device: gradually increasing an RF transmission power of the RF interface when the connection procedure is implemented, so as to eliminate or reduce a phenomenon of migration of the node device from a favourite communication network to another communication network in said plurality of communication networks.

Thus, by gradually increasing the RF transmission power of the RF interface when the connection procedure is implemented, the proposed solution makes it possible to eliminate or reduce the migration phenomenon since it favours a connection of the node device using the PLC interface (the case guaranteeing a connection to the favourite communication network as defined above) or using the RF interface but with low power (at the start of the connection procedure) and therefore via an RF connection with another physically very close node device (or the concentrator device), which increases the chances that the connection takes place with the favourite communication network (the node device being deployed in the geographical area of the favourite communication network).

According to a particular embodiment, the gradual increase in the RF transmission power comprises an initial plateau, with a nonzero RF transmission power value, and a final plateau, with a final RF transmission power value higher than the initial value.

Such an increase by plateaux is a simple to implement.

According to a particular embodiment, the gradual increase in the RF transmission power comprises at least one intermediate plateau, with an intermediate RF transmission power value higher than the initial value and lower than the final value.

The intermediate plateau increases the chances of arriving at a connection before reaching the final plateau, and therefore limiting the physical distance at which there is located another node device (fulfilling the role of relay node), or the concentrator device, with which the node device comes into communication via the RF connection.

According to a particular embodiment, each plateau other than the initial plateau begins at a time that is determined randomly or pseudo-randomly within a predetermined interval of time and defined with respect to a time of initial start-up or reboot of the node device.

This makes it possible to avoid node devices belonging to one and the same geographical area, and rebooting simultaneously after electricity returns following an outage, simultaneously increasing their RF transmission powers (which could cause a simultaneous updating, in these node devices, of the route to the concentrator device).

According to a particular embodiment, after each increase in the RF transmission power that resulted in a connection via the RF interface, updating a route from the node device to the concentrator device.

This affords an improvement in the topology of the communication network by taking into consideration the effect of the new RF transmission power.

According to a particular embodiment, after each connection, referred to as current connection to a current communication network, following the initial start-up or a hardware or software reboot of the node device:
updating a connection table associating a number of connections with each communication network of a subset of communication networks among the plurality of communication networks;
calculating a percentage, denoted D, of connections to the current communication network, according to the total number S of connections mentioned in the connection table; and
planning, according to the total number S of connections mentioned in the connection table and the percentage D of connections to the current communication network, a time at which to implement a future software reboot of the node device.

The planning thus proposed makes it possible to more quickly converge towards a situation where the node device succeeds in connecting with its favourite communication network (as defined above), in the case where another prior connection takes place with another (neighbouring) communication network. In fact gradually increasing the RF transmission power of the RF interface when the connection procedure is implemented (i.e. the first mechanism of the proposed solution, described above) does not completely prevent the node device being able to connect, via an RF connection, to a neighbouring communication network rather than to the favourite communication network (but the probability of such a conclusion remains very low).

According to a particular embodiment, the updating of the connection table comprises:
if the current communication network is not already present in the connection table, adding a new entry in the connection table for the current communication network and with a number of connections equal to one;
if the current communication network is already present in the connection table, incrementing by “one” the number of connections associated with the current communication network in the connection table;
calculating the total number S of connections mentioned in the connection table, and:
   if S≤N_connections_Max, with N_connections_Max a maximum number of connections authorised, ending the updating of the connection table; and
   if S>N_connections_Max, decrementing by “one” the number of connections associated with the communication network which, apart from the current communication network, has the smallest number of connections in the connection table, so that after decrementation S is equal to N_connections_Max.

Thus the connection table constitutes a history of the connections to the most relevant communication networks, while limiting the memory resources necessary by virtue of the parameter N_connexions_Max.

According to a particular embodiment, the planning of the instant at which to implement the next software reboot of the node device comprises:
if S<N_connections_Max, planning the next reboot after a first period; and
if S=N_connexions_Max, planning the next reboot according to the percentage D of connections to the current communication network, in accordance with a set of rules comprising:
   if D≥Threshold_H, with Threshold_H a first predetermined threshold, not planning the next reboot;
   if D<Threshold_H:
      if D<Threshold_B, with Threshold_B a second predetermined threshold lower than Threshold-H, planning the next reboot after the first period; and
      if Threshold_B≤D<Threshold_H, planning the next reboot after a second period longer than the first period.

Thus, as from the moment when S becomes equal to N_connections_Max, account is taken of the percentage D of connections to the current communication network to decide on the planning of the next reboot. It is considered that, the higher D is, the longer it is possible to wait before the next reboot, since the higher D is, the higher the probability of a connection to the favourite communication network. This makes it possible to limit the number of reboots while guaranteeing good convergence towards a situation in which the node device is connected to its favourite communication network.

According to a particular embodiment, the node device is a smart meter.

According to a particular embodiment, the communication networks are personal area networks.

A computer program product is also proposed here, comprising instructions causing the execution, but a processor, of the above-mentioned method according to any one of the embodiments thereof, when said instructions are executed by the processor.

A storage medium is also proposed, storing such instructions causing the execution, by the processor, of the method mentioned above according to any one of the embodiments thereof, when said instructions are read from the storage medium and executed by the processor.

A node device is also proposed comprising a first powerline communication interface, referred to as a PLC interface, and a second radio-frequency communication interface, referred to as an RF interface, each of the PLC and RF interfaces being configured to implement a procedure for connecting the node device to any one of a plurality of communication networks, each of the communication networks being of the mesh type and comprising a concentrator device to which a set of node devices can connect, the node device comprising electronic circuitry configured to implement the method mentioned above according to any one of the embodiments thereof.

### BRIEF DESCRIPTION OF THE DRAWINGS

The features of the invention mentioned above, as well as others, will emerge more clearly from the reading of the following description of at least one example embodiment, said description being made in relation to the accompanying drawings, among which:

FIG. 1 illustrates schematically a global network comprising a plurality of personal area networks and wherein the invention can be implemented;

FIG. 2 illustrates schematically one of the personal area networks of FIG. 1, in one embodiment;

FIG. 3 illustrates schematically an example of hardware architecture of a node device (here a smart electricity meter), in one embodiment;

FIG. 4 illustrates schematically an example of electronic circuitry included in the smart electricity meter of FIG. 3 and detailing the operation of an application processor, in one embodiment;

FIG. 5 illustrates schematically an example of an on-site deployment algorithm executed by the smart electricity meter of FIG. 3;

FIG. 6 illustrates schematically an example of the change, as a function of time, in the RF transmission power of the RF interface of the smart electricity meter of FIG. 3;

FIG. 7 is a detail of the step 501 of FIG. 5 and illustrates schematically an example of an algorithm for change in the RF transmission power of the RF interface of the smart electricity meter of FIG. 3;

FIG. 8 is a detail of the step 503 of FIG. 5 and illustrates schematically an example of an algorithm for updating the connection table; and

FIG. 9 is a detail of the step 504 of FIG. 5 and illustrates schematically an example of an algorithm for planning the next reboot of the smart electricity meter.

### DETAILED DISCLOSURE OF EMBODIMENTS

The present invention relates to a method for the deployment on site of a PLC and RF hybrid node device, i.e. comprising a PLC communication interface and an RF communication interface. Each of the PLC and RF interfaces is configured to implement a procedure for connecting the node device to any one of a plurality of communication networks. Each of these communication networks is of the mesh type and comprises a concentrator device to which a set of node devices can connect (logical topology in tree form).

In the remainder of the description, the particular case is considered by way of illustrative example where the hybrid node device is a communicating electricity meter (also called a “intelligent meter” or “smart meter”) used for a smart-metering application and where the communication networks are personal area networks (PANs).

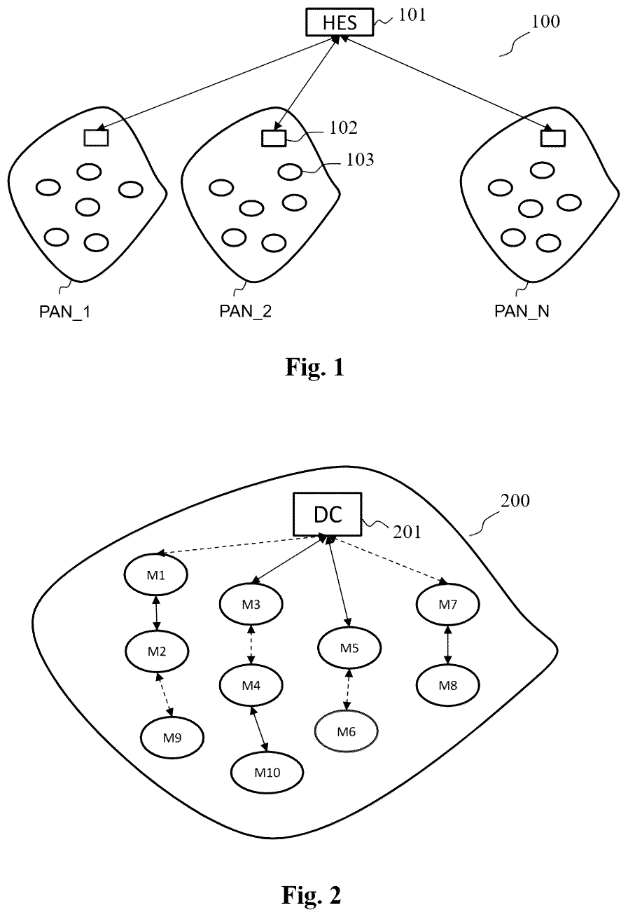

Thus, FIG. 1 illustrates schematically a global network 100 for a smart-metering application, comprising a plurality of personal area networks PAN_1 to PAN_N and wherein the invention can be implemented. Each personal area network is managed by a data concentrator device 102 that fulfils a dual role of collector and gateway. Each concentrator device 102 makes it possible to communicate firstly with smart electricity meters 103, via PLC and RF connections, thus forming a mesh network, and secondly with a head end system (HES) 101 via another communication protocol (for example in accordance with cellular communication technology).

FIG. 2 illustrates schematically one of the personal area networks PAN_1 to PAN_N of FIG. 1, in one embodiment. The personal area network considered in FIG. 2 is referenced 200 and is composed of a data concentrator device 201 (DC) and a plurality of smart electricity meters M1 to M10. The data concentrator device and the smart electricity meters are equipped with two communication interfaces, PLC and RF. The meters M1 to M10 form a mesh network with the concentrator device DC, using mixed communication connections PLC (arrows in continuous lines) and RF (arrows in broken lines). By way of example, the meter M10 makes it possible to communicate with the data concentrator DC via three hops: two PLC hops (PLC connection between M10 and M4 and PLC connection between M3 and DC) and one RF hop (RF connection between M4 and M3).

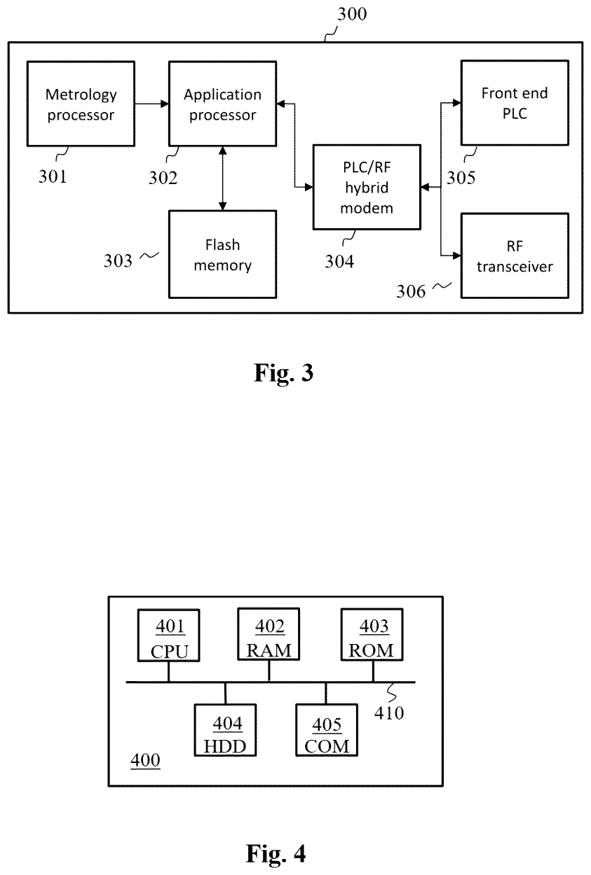

In the embodiment illustrated in FIG. 3, a PLC and RF hybrid electricity meter (here referenced 300) has a hardware architecture comprising:
a metrology processor 301 which, as its name indicates, is used for metrology;
a flash memory 303 storing an application (software) program and a (software) program for managing the bottom layers of a protocol stack of a PLC and RF hybrid modem 304;
an application processor 302 executing an application program that makes it possible to manage the algorithm proposed in the present invention (method for on-site deployment of a node device with, in one embodiment, a gradual increase in the RF transmission power during the execution of a procedure for connection to a personal area network, an updating of a connection table and planning of a next software reboot of the node device);
the PLC and RF hybrid modem 304 that integrates the bottom layers of the hybrid protocol stack (for example in accordance with the hybrid G3-PLC standard or the hybrid PRIME standard);
a PLC interface (“front end PLC”) 305 for interfacing the hybrid modem 304 with a PLC transmission line; and
an RF interface (“RF transceiver”) 306 for interfacing the hybrid modem 304 with an RF transmission medium.

With regard to PLC and RF hybrid communication technology, the smart electricity meter 300 has available for example the protocol stack of the G3-PLC standard specified in the ITU-T recommendation G.9903, as from the 2021 version that incorporates the hybrid mode, or that of the PRIME (“PoweRline Intelligent Metering Evolution”) standard, as from the 2022 version that incorporates the hybrid mode.

FIG. 4 illustrates schematically an example of electronic circuitry 400 included in the smart electricity meter 300 of FIG. 3 and detailing the operation of an application processor 302, in one embodiment.

The electronic circuitry 400 then comprises, connected by a communication bus 410: a processor (or CPU, standing for “Central Processing Unit”) 401 (corresponding to the application processor 302 of FIG. 3); a random access memory (RAM) 402, a read-only memory (ROM) 403 (corresponding to the flash memory 303 of FIG. 3); a data storage device, such as a hard disk (or HDD, standing for “hard disk drive”) or a storage medium reader (such as an SD (“Secure Digital”) card reader 404; and at least one communication interface 405.

The processor 401 is capable of executing instructions that form a computer program and are loaded in the RAM 402 from the ROM 403, from an external memory (not shown), from another storage medium (such as an SD card), or from a communication network (not shown). When the electronic circuitry 400 is powered up, the processor 401 is capable of reading the aforementioned instructions from the RAM 402 and executing them. When they are read (from the RAM 402 or a storage medium) and executed by the processor 401, these instructions (which form a computer program) cause the execution, by the processor 401, of the behaviours, steps and algorithm described here.

All or some of the behaviours, steps and algorithm described here can thus be implemented in software form by executing a set of instructions by a programmable machine, such as a DSP (“digital signal processor”) or a microcontroller, or be implemented in hardware form by a machine or a dedicated component (“chip”) or a dedicated set of components (“chipset”), such as an FPGA (“field-programmable gate array”) or an ASIC (“application-specific integrated circuit”). In general terms, the electronic circuitry 400 is arranged and configured to implement the behaviours, steps and algorithms described here.

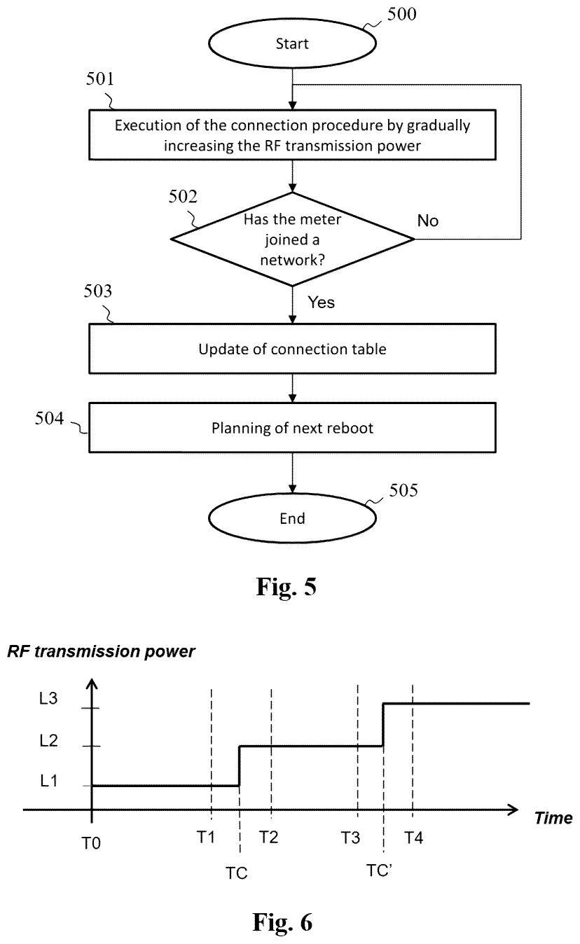

FIG. 5 illustrates schematically an example of an on-site deployment algorithm. It is executed by the smart electricity meter 300 of FIG. 3 (and more precisely its application processor 302) at the initial start-up of the meter and then at each reboot (hardware or software) of the meter.

After the algorithm is launched (start step 500), the meter performs the step 501 in which it gradually increases the RF transmission power of the RF interface when the connection procedure is implemented, so as to eliminate or reduce a phenomenon of migration of the meter (node device) 300 from a favourite communication network to another communication network in the plurality of personal area networks PAN_1 to PAN_N. As already defined above, favourite personal area network for an electricity meter means the personal area network the concentrator device of which is installed in the LV (low voltage) station from which the electrical distribution network on which this electricity meter is installed originates.

This enables the meter to have priority for joining a personal area network, either through a PLC connection (established by means of its PLC interface) with another meter (or the concentrator device) or through an RF connection (established by means of its RF interface) with another meter (or the concentrator device), that is very close physically. It should be noted that this step does not completely prevent a meter belonging to a given geographical area then joining, via an RF connection, not its favourite personal area network but a neighbouring personal area network corresponding to another geographical area. To manage such a situation, the probability of which is very low, the steps 503 and 504 described below aim to increase the chances of the meter as quickly as possible joining its favourite personal area network (improving convergence towards the favourite personal area network).

As already mentioned above, favourite personal area network for a smart electricity meter means the personal area network the concentrator device of which is installed in the LV (low voltage) electricity transformer substation from which the electrical distribution network on which this electricity meter is installed originates.

In a step 502, the meter checks whether it has joined (i.e. whether it has connected to) one of the personal area networks PAN-1 to PAN N. If it has not connected to one of the personal area networks (response “no” to the test of the step 502), the meter once again performs the step 501. If it has succeeded in connecting to one of the personal area networks (response “yes” to the test of the step 502), via the PLC interface or the RF interface, the meter performs the step 503, in which it updates a connection table associating a number of connections with each communication network in a subset of communication networks from the plurality of communication networks PAN-1 to PAN_N, then the step 504, in which it plans, according to a total number S of connections mentioned in the connection table and a percentage D of connections to the current communication network (itself calculated according to S), a time at which to implement a future (software) reboot, and finally it passes to the end step 505.

As detailed hereinafter, the connection table of the electricity meter contains the history of the connections of the meter to the most relevant personal area networks, i.e. the personal area networks most used during the last operations of connection of the meter in question. At a given moment, a personal area network is said to be relevant if it is the personal area network to which the electricity meter is connected (it is also called the current personal area network) or a personal area network to which the meter has been connected several times in the recent past.

### Detailed Discussion of the Step 501 of Gradual Increase in the Transmission Power

After a software or hardware reboot, a PLC and RF hybrid electricity meter attempts to join a personal area network by sending a beacon frame or a frame of the Promotion Needed Protocol Data Unit (PNPDU) type over the two PLC and RF communication interfaces.

A PNPDU frame is a frame sent by a smart electricity meter that wishes to join the network but has not received beacon frames (see section 4.4.3 of the latest version of the PRIME 1.4 specification published on 17 Nov. 2023).

Physically, the PLC signals transmitted by the meter are attenuated and blocked at the LV electricity transformer substation (in which the concentrator device of the favourite personal area network is installed) while the RF signals can propagate in free space. This means that the meter in question can start the procedure of connection to a neighbouring personal area network, via an RF communication connection.

The radio-frequency parameters (frequency band, modulation, transmission rate, frequency deviation, spacing between the frequency transmission channels, etc) are for example defined in the two standards IEEE 802.15.4aa™-2022 published in February 2022 and IEEE 802.15.4™-2020 (revision of IEEE 802.15.4-2015). The frequency band used in Europe is 863-876 MHz while the frequency band 902-928 MHz is used in the United States.

In order to reduce the effect of the RF propagation of the signals, the general principle of the present invention is, with regard to the RF interface of the meter, to restart the connection procedure using a minimum power for the RF transmission. Then this RF transmission power increases as a function of time, in order finally to stabilise at a nominal value fixed by the regulations.

Taking the case of Europe, the maximum RF transmission power allowed by the regulations depends on the frequency band used. These values are defined in Annex B of ETSI EN 300 220-2 V3.1.1 published in February 2017. For example, in the band [869.4-869.65 MHz], the maximum effective radiated power (ERP) can be as much as +27 dBm (equivalent to 500 mW).

FIG. 6 illustrates schematically an example of the change, as a function of time, in the RF transmission power of the RF interface of the smart electricity meter of FIG. 3. In this example of change, the gradual increase in the transmission power RF comprises:
an initial plateau, with an initial nonzero RF transmission power value L1 (referred to as “Low”);
an intermediate plateau, with an intermediate RF transmission power value L2 (referred to as “Medium”) higher than the initial value L1; and
a final plateau, with a final RF transmission power value L3 (referred to as “Nominal”) higher than the intermediate value L2.

In a variant, there is no intermediate plateau. In another variant, there are a plurality of intermediate plateaux.

For example and for an on-site deployment in PLC and RF hybrid technology in Europe and if [869.4-869.65 MHz] is used as the frequency band, the maximum power allowed by the regulations equal to +27 dBm. In this case, it is possible to use, in an implementation of the present invention, the following three RF transmission power levels:

$$L 1 ( low level ) = - 25 dBm ( equivalent to 3 \times {10}^{- 3} mW ) ;$$

$$L 2 ( medium level ) = 0 dBm ( equivalent to 1 mW ) ; and$$

$$L 3 ( nominal level ) = + 27 dBm ( equivalent to 500 mW ) .$$

The times T0, T1, T2, T3 and T4, as well as TC and TC′, are defined as follows:
T0: time of reboot (software or hardware) of the smart electricity meter;
T1, T2: two times between which the meter selects a random time (TC) at which its RF transmission power increases from the low value L1 to the medium value L2; and
T3, T4: two times between which the meter selects a random time (TC′) at which its RF transmission power increases from the medium value L2 to the nominal value L3.

Selecting pairs of times (T1, T2) and (T3, T4) essentially makes it possible to avoid the smart electricity meters belonging to one and the same geographical area simultaneously increasing their RF transmission powers after a return of electricity following an outage.

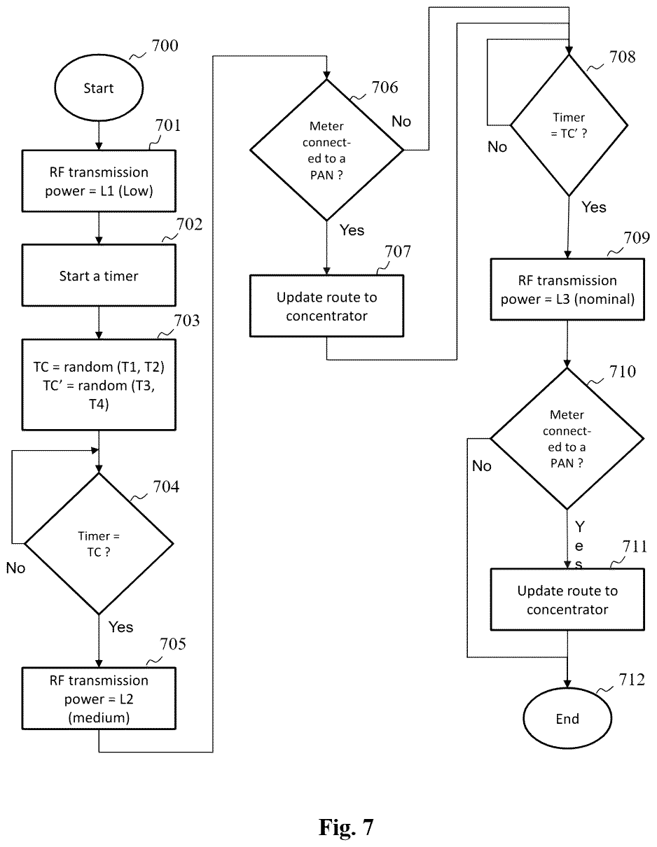

FIG. 7 is a detail of the step 501 of FIG. 5 and illustrates schematically an example of an algorithm for increasing the RF transmission power of the RF interface of the smart electricity meter of FIG. 3.

A function that generates a random integer number belonging to the interval [x; y] is denoted random (x, y).

After the algorithm is launched (start step 700), the meter performs the step 701 in which the RF interface commences with an RF transmission power equal to the value L1 (low). In a step 702, the meter starts a timer. In a step 703, the meter initialises the variables TC and TC′ as follows: TC=random (T1, T2) and TC′=random (T3, T4).

In a test step 704, the meter detects whether the condition “Timer=TC” is satisfied. If not (response “no” to the test of the step 704), the meter loops back to the step 704. If so (response “yes” to the test of the step 704, the meter performs the step 705 in which the RF interface increases the RF transmission power by passing from the value L1 (low) to the value L2 (medium).

The step 705 is followed by the test step 706 in which the meter determines whether it has succeeded in connecting to a personal area network (PAN).

If it has succeeded in connecting to a personal area network (response “yes” at the test step 706, the meter performs the step 707, in which it updates its route to the concentrator device, and then the test step 708, in which it detects whether the condition “Timer=TC“ ” is satisfied. It has not succeeded in connecting to a personal area network (response “no” at the test step 706), the meter directly performs the test step 708.

In the case of a response “no” to the test of the step 708, the meter loops back to the step 708. In the case of a response “yes” to the test of the step 708, the meter performs the step 709 in which the RF interface increases the RF transmission power by passing from the value L2 (medium) to the value L3 (nominal).

The step 709 is followed by the test step 710 in which the meter determines whether it has succeeded in connecting to a personal area network (PAN). In the case of a response “yes” at the test step 710, the meter performs the step 711, in which it updates its route to the concentrator device, before arriving at the end step 712. In the case of a response “no” at the test step 710, the meter passes directly to the end step 712.

It should be noted that, even if it has succeeded in connecting to a personal area network with a low (L1) or medium (L2) RF transmission power, the meter continues to gradually increase its RF transmission power so as finally to reach the nominal power (L3). This gradual increase in the RF transmission power up to the nominal value (L3) is highly advantageous for constructing the whole of the personal area network (mesh network), in which the meter considered here can fulfil the role of repeater for other meters.

It should also be noted that, after each increase in the RF transmission power followed by a connection to a personal area network, the smart electricity meter updates its route to the data concentrator device (see steps 707 and 711). This affords an improvement in the topology of the hybrid personal network by taking into consideration the effect of the new RF transmission power.

For example, on the basis of the hybrid specification of the G3-PLC standard and in order to update or establish a new route to the data concentrator device, the smart electricity meter launches the primitive “G3ADP-ROUTEDISCOVERY.Request” with the following parameters:
DSTADDR=0x0000;
MAXHOPS=XX, where XX means any value coded in 1 byte;
NEXTHOP=0xFFFF; and
MEDIATYPE=YY, where YY means a value coded in 1 byte and which can be 0 or 1.

These parameters are defined in the ITU-T recommendation G.9903, 2021 version, which incorporates the hybrid profile as follows:
DSTADDR represents the final destination address coded in 16 bits;
MAXHOPS is the maximum number of hops authorised by the hybrid protocol for an electricity meter to be able to communicate with the data concentrator device;
NEXTHOP represents the address of the next hop, if already known, to which the RREQ will be transmitted. If the NEXTHOP is defined with 0xFFFF, the route-discovery procedure will be implemented; and
MEDIATYPE is the type of transmission channel used for communicating with the NEXTHOP (0x00: PLC; 0x01: RF).

### Detailed Discussion of the Step 503 of Updating the Connection Table

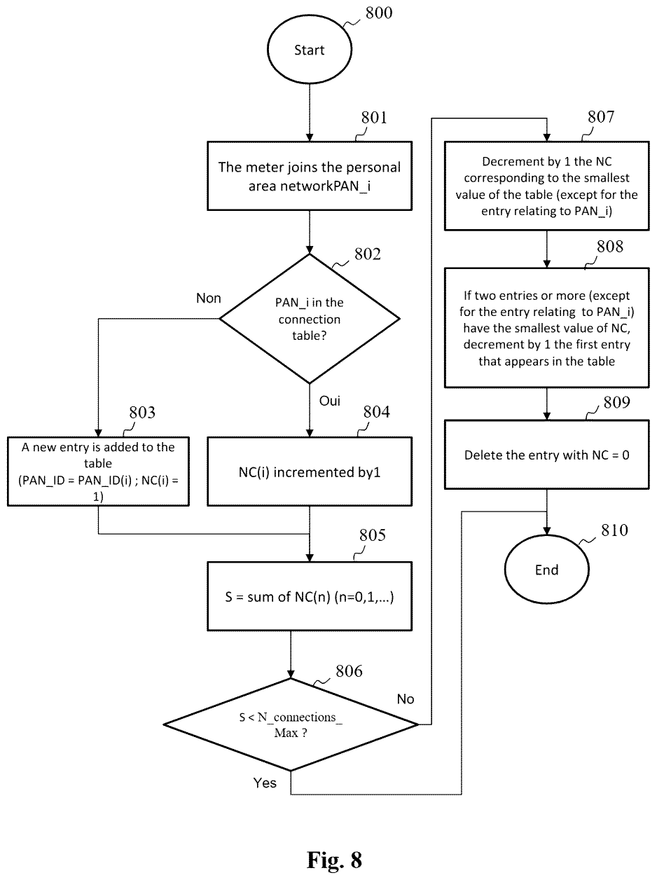

FIG. 8 is a detail of the step 503 of FIG. 5 and illustrates schematically an example of an algorithm for updating the connection table.

Each entry “i” in this connection table is a pair (PAN_ID(i), NC(i)) where
PAN_ID(i) is a personal area network identifier (PAN_ID), coded in two bytes; and
NC(i) is a number of connections of the meter to this personal area network, coded in one byte.

By way of example, the following table 1 shows a connection table of an electricity meter after nine reboots:

TABLE 1

| PAN_ID | NC |
|---|---|
| 0x1111 | 5 |
| 0x2222 | 1 |
| 0x3333 | 2 |
| 0x4444 | 1 |

In this example, the meter has been registered five times to the personal area network of ID=0x1111, twice to the personal area network of ID=0x3333 and only once to the personal area network of ID=0x2222 and to the personal area network of ID=0x4444.

With the objective of refining the history of the connections and to limit the memory size of the connection table, only a limited number of connections are taken into consideration. This number is denoted by “N_connexions_Max”. Thus the maximum size of the connection table is equal to “N_connexions_Max” entries.

The connection table is updated automatically by the smart electricity meter, after each connection to a personal area network. It is therefore supposed that, after software or hardware rebooting, the electricity meter is connected to a current personal area network PAN_ID(i) (at the end of the step 801 following the start step 800).

In a test step 802, the meter checks whether the current personal area network PAN_ID(i) is already present in the connection table. In the case of a response “no” at the test step 802, the meter performs a step 803, in which it adds a new entry in the connection table for the current personal area network (PAN_ID=PAN_ID(i)) and with a number of connections equal to one (NC=NC(i)=1). In the case of a response “yes” at the test step 802, the meter performs a step 804, in which it increments by “one” the number of connections NC(i) associated with the current personal area network (PAN_ID(i)) in the connection table.

After the step 803 or 804, the meter performs the step 805, in which it calculates the total number S of connections mentioned in the connection table (S=sum of NC(n) with n=0,1, . . . ), and then the step 806, in which it detects whether the condition “S≤N_connections_Max” is satisfied.

In the case of a response “no” at the test step 806, the meter ends the updating of the connection table (end step 810).

In the case of a response “yes” at the test step 806, the meter performs the step 807, in which it decrements by “one” the number of connections (NC) associated with the personal area network which, apart from the current personal network, has the smallest number of connections in the connection table. Thus, after decrementation, S is equal to N_connections_Max. In the step 808, which supplements the step 807, if two entries or more have the same smallest number of connections, with exception of the entry for the current personal area network, then the first entry that appears in the connection table is allocated by decrementing its number of connections (NC) by “one” In the step 809, the meter deletes from the connection table any entry the number of connections (NC) of which is equal to zero, and then it passes to the end step 810.

By way of example, the following table 2 shows a connection table of a smart electricity meter before updating:

TABLE 2

| | Number of |
|---|---|
| PAN ID | connections (NC) |
| 0x5777 | 4 |
| 0x7755 | 4 |
| 0x4545 | 2 |

It is supposed that “N_connections_Max”=10 and that, after a software or hardware and reboot, the meter in question has joined the personal area network of ID=0x4545 (current personal area network). The number of connections corresponding to PAN_ID=0x4545 is therefore incremented by “one” and becomes equal to three.

The sum S of numbers of connections after the connection to the current personal area network of ID 0x4545 is given by: S=4+4+3=11.

S is greater than “N_connections_Max”, and therefore the meter increments by “one” the number of connections corresponding to the entry that has the smallest value of NC with the exception of the current personal area network 0x4545. Here the two PAN ID 0x5777 and 0x7755 have a number of connections equal to 4. Therefore the number of connections corresponding to PAN ID 0x5777 is decremented by “one” and becomes equal to three.

The connection table after this update is given by the following table 3:

TABLE 3

| | Number of |
|---|---|
| PAN ID | connections (NC) |
| 0x5777 | 3 |
| 0x7755 | 4 |
| 0x4545 | 3 |

### Detailed Discussion of the Step 504 of Planning the Next Reboot

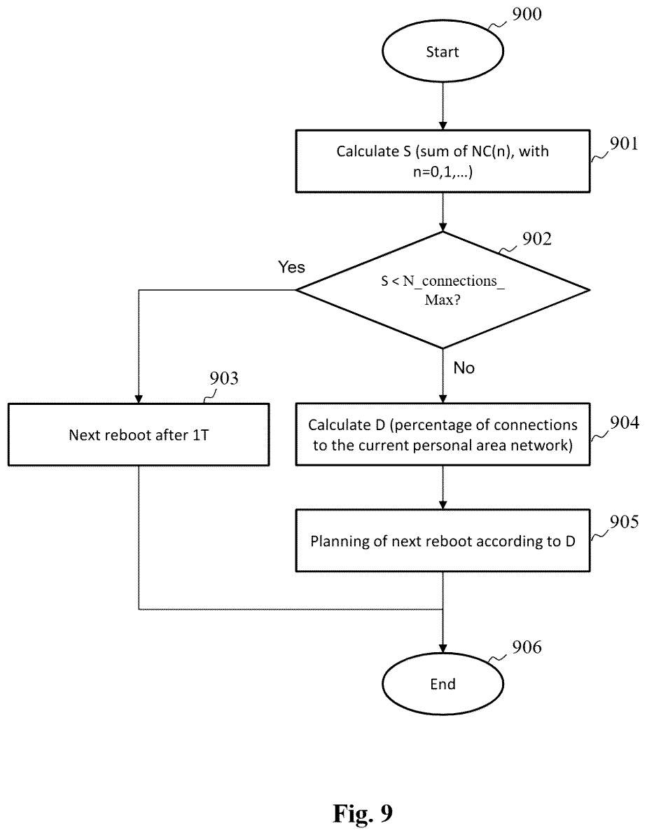

FIG. 9 is a detail of the step 504 of FIG. 5 and illustrates schematically an example of an algorithm for planning the next reboot of the smart electricity meter. As explained above, after the connection to a personal area network and the updating of its connection table, the smart electricity meter plans the time of the next reboot.

After the launch of the algorithm (start step 900), the meter performs the step 901, in which it calculates the total number S of connections mentioned in the connection table after the update step (S=sum of NC(n) with n=0,1, . . . ), and then the step 902, in which it detects whether the condition “S<N_connections_Max” is satisfied.

In the case of a response “yes” at the test step 902, the meter performs the step 903, in which it plans the next reboot after a first period (T), and then passes to the end step 906.

In the case of a response “no” at the test step 902 (i.e. if S=N_connexions_Max), the meter performs the step 904, in which it calculates a percentage, denoted D, of connections to the current personal area network as a function of S (calculated at the step 902), then the step 905, in which it plans the next reboot as a function of D, in accordance with a predetermined rules, and finally it passes to the end step 906.

In a first implementation, the meter uses the following set of rules:
if D≥Threshold_H, with Threshold_H a first predetermined threshold (for example 90%), not planning the next reboot;
if D<Threshold_H:
   if D<Threshold_B, with Threshold_B a second predetermined threshold (for example 30%) lower than Threshold-H, planning the next reboot after the first period (T); and
   if Threshold_B≤D<Threshold_H, planning the next reboot after a second period (for example 2T or 3T) longer than the first period (T).

In a second implementation, the meter uses the set of rules defined by the following Table 4 (lookup table for planning the next reboot):

TABLE 4

| D (%) | Next software reboot after: |
|---|---|
| D < 30 | 1T |
| 30 =< D < 60 | 2T |
| 60 =< D < 90 | 3T |
| D >= 90 | No software reboot |

By way of example, the last example discussed above is taken, where the connection table after update is given by Table 3. It is supposed that T=24 hours. According to the connection table after update, S=N_connections_Max, and therefore the meter calculates the percentage connection to the current personal network of PAN ID=0x4545. Here D=30%. According to the lookup table (Table 4), the next reboot will be planned after 2T, i.e. after two days.

1. A method for deploying on site a hybrid node device comprising a first powerline communication (“PLC”) interface, and a second radio-frequency communication (“RF”) interface, each of the PLC and RF interfaces being configured to implement a procedure for connecting the node device to any one of a plurality of communication networks, each of the communication networks being of the mesh type and comprising a concentrator device to which a set of node devices can connect, the method being implemented by electronic circuitry included in the node device, the method comprising”
at initial start-up and then at each hardware or software reboot of the node device:
gradually increasing an RF transmission power of the RF interface when the connection procedure is implemented, so as to eliminate or reduce a phenomenon of migration of the node device from a favourite communication network to another communication network in said plurality of communication networks.

2. The method according to claim 1, wherein the gradual increase in the RF transmission power comprises an initial plateau, with a nonzero RF transmission power value, and a final plateau, with a final RF transmission power value higher than the initial value.

3. The method according to claim 2, wherein the gradual increase in the RF transmission power comprises at least one intermediate plateau, with an intermediate RF transmission power value higher than the initial value and lower than the final value.

4. The method according to claim 2, wherein each plateau other than the initial plateau begins at a time that is determined randomly or pseudo-randomly within a predetermined interval of time and defined with respect to a time (TO) of initial start-up or reboot of the node device.

5. The method according to claim 1, comprising, after each increase in the RF transmission power that resulted in a connection via the RF interface, updating a route from the node device to the concentrator device.

6. The method according to claim 1, comprising, after each connection, referred to as current connection to a current communication network, following the initial start-up or a hardware or software reboot of the node device:
updating a connection table associating a number of connections to each communication network of a subset of communication networks among the plurality of communication networks;
calculating a percentage, of connections to the current communication network, according to the total number S of connections mentioned in the connection table; and
planning according to the total number S of connections mentioned in the connection table and the percentage D of connections to the current communication network, a time at which to implement a future software reboot of the node device.

7. The method according to claim 6, wherein the updating of the connection table comprises:
if the current communication network is not already present in the connection table, adding a new entry in the connection table for the current communication network and with a number of connections equal to one;
if the current communication network is already present in the connection table, incrementing by “one” the number of connections associated with the current communication network in the connection table;
calculating the total number S of connections mentioned in the connection table, and:
if S≤N_connections_Max, with N_connections_Max being a maximum number of connections authorised, ending the updating of the connection table; and
if S>N_connections_Max, decrementing by “one” the number of connections associated with the communication network which, apart from the current communication network, has the smallest number of connections in the connection table, so that after decrementation S is equal to N_connections_Max.

8. The method according to claim 7, wherein the planning of the instant at which to implement the next software reboot of the node device comprises:
if S<N_connections_Max, planning the next reboot after a first period (T); and
if S=N_connexions_Max, planning the next reboot according to the percentage D of connections to the current communication network, in accordance with a set of rules comprising:
if D≥Threshold_H, with Threshold_H a first predetermined threshold, not planning the next reboot;
if D<Threshold_H:
if D<Threshold_B, with Threshold_B a second predetermined threshold lower than Threshold-H, planning the next reboot after the first period; and
if Threshold_B≤D<Threshold_H, planning the next reboot after a second period (for example 2T or 3T) longer than the first period.

9. The method according to claim 1, wherein the node device is a smart meter.

10. The method according to claim 1, wherein the communication networks are personal area networks.

11. (canceled)

12. A non-transitory storage medium, storing a computer program comprising instructions causing the execution, by a processor, of the method according to claim 1, when said instructions are read from the storage medium and executed by the processor.

13. A node device comprising:
a first powerline communication (“PLC”) interface;
a second radio-frequency communication (“RF”) interface, each of the PLC and RF interfaces being configured to implement a procedure for connecting the node device to any one of a plurality of communication networks, each of the communication networks being of the mesh type and comprising a concentrator device to which a set of node devices can connect; and
electronic circuitry configured to implement the method according to claim 1.
